(19) United States
(12) Patent Application Publication
(10) Pub. No.: US 2010/0333073 A1
(43) Pub. Date: Dec. 30, 2010

(54) SYSTEMS AND METHODS FOR AUTOMATED GENERATION OF SOFTWARE TESTS BASED ON MODELING THE SOFTWARE TEST DOMAIN

(75) Inventor: Laura Mills, Maple Grove, MN (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/494,021

(22) Filed: Jun. 29, 2009

(51) Int. Cl. G06F 9/44

(52) U.S. Cl. 717/131

(57) ABSTRACT

Systems and methods for automatically generating test procedures for a software application. In an example method a user creates a test case model based on requirements associated with the software application under test. The user then generates an interface control document. The interface control document includes associations of information between the requirements and the test case model. Next, a processing device automatically generates test procedures for the software application under test based on the interface control document, the requirements and the test case model. The processor automatically creates a local copy of the test case model based on the interface control document.

### BACKGROUND OF THE INVENTION

A typical approach for software testing requirements is to do the following: 1) Generate test cases that cover testing the requirement; 2) Generate test procedures/test vectors to run the test in the associated testing environment. Typically, both test cases (FIG. 1-2) and test procedures (FIG. 1-3) are generated by hand based on the requirement (FIG. 1-1). Errors can occur between the translation of the requirements to the test case and from the test case to the procedure.

To eliminate some of the errors in the translation from the test case to the test procedure, tools have been created to automate the test procedure from the test case. These tools rely on putting specific test procedure information in the test case as shown in FIG. 1-4.

There are two major disadvantages to this method of automation. Without the symbolic information in the test case, there needs to be an additional translation step in understanding how the test case properly exercises the requirement. As the logic for a requirement gets more complicated, it becomes more difficult to determine which condition of the requirement is getting exercised. By putting software values in the test case, these test cases need to be updated any time there is a software change, even if there is not a requirement change. For example, if the validity interface changes from 1=Valid to 0=Valid, then the test case needs to be updated. Now the test case is not only dependent on requirement changes, but is dependent on software changes as well.

### SUMMARY OF THE INVENTION

The present invention provides systems and methods for automatically generating test procedures for a software application. In an example method a user creates a test case model based on requirements associated with the software application under test. The user then generates an interface control document. The interface control document includes associations of information between the requirements and the test case model. Next, a processing device automatically generates test procedures for the software application under test based on the interface control document, the requirements and the test case model.

In one aspect of the invention, the processor automatically creates a local copy of the test case model based on the interface control document. The local copy includes status values, data values and validity values as defined by the interface control document. The status values and the validity values are bit values as defined in the interface control document. The local copy also includes frequency information as defined in the interface control document. The processor automatically generates the test procedures based on the local copy of the test case model.

### BRIEF DESCRIPTION OF THE DRAWINGS

Preferred and alternative embodiments of the present invention are described in detail below with reference to the following drawings:

FIGS. 1-2 thru 1-4 illustrate an example requirements, test cases and test procedure as manually executed in accordance with the prior art;

FIG. 2 illustrates an example computer system that performs automated generation of software test procedures as formed in accordance with an embodiment of the present invention;

FIG. 3-1 thru 3-3 illustrate flow diagrams of an example process performed by the system shown in FIG. 2;

FIG. 4-1 illustrates requirements for an example software test domain;

FIG. 4-2 illustrates a plurality of test cases formed in accordance with the requirements shown in FIG. 4-1;

FIG. 4-3 illustrates a software interface control document formed in accordance with an embodiment of the present invention; and

FIGS. 5 thru 8 illustrate transformations of the test cases shown in FIG. 4-2 based on the interface control document shown in FIG. 4-3.

### DETAILED DESCRIPTION OF THE INVENTION

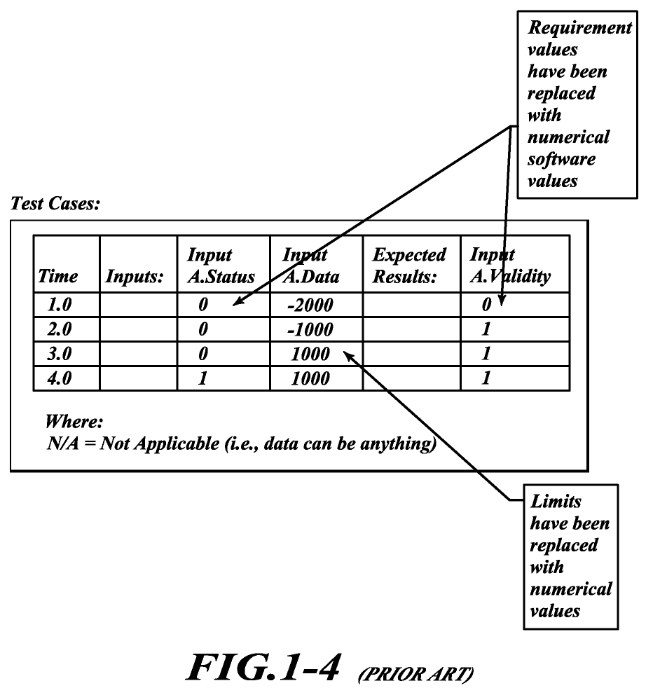

The present invention provides processes for automatically generating test procedures on a computer system (FIG. 2) based on predefined one or more test cases and requirements. The present invention maintains the test cases as an analytical description or “model” such that requirements, analysis and review are still performed on the test cases without obscuration by any code-specific information. The test procedure, when generated from a test-case “model”, will contain the code-specific information such that the test can be run automatically on software embedded in the computer system 20.

The software of the present invention may be used in a formal software verification process. Once a test-case model is created, associations between the model and software are defined through a user interface control document. After the model and associations are created, the test procedure is automatically generated by the computer system 20 for the specific test environment. The created test procedure can then be run on a target environment (based on a user test harness).

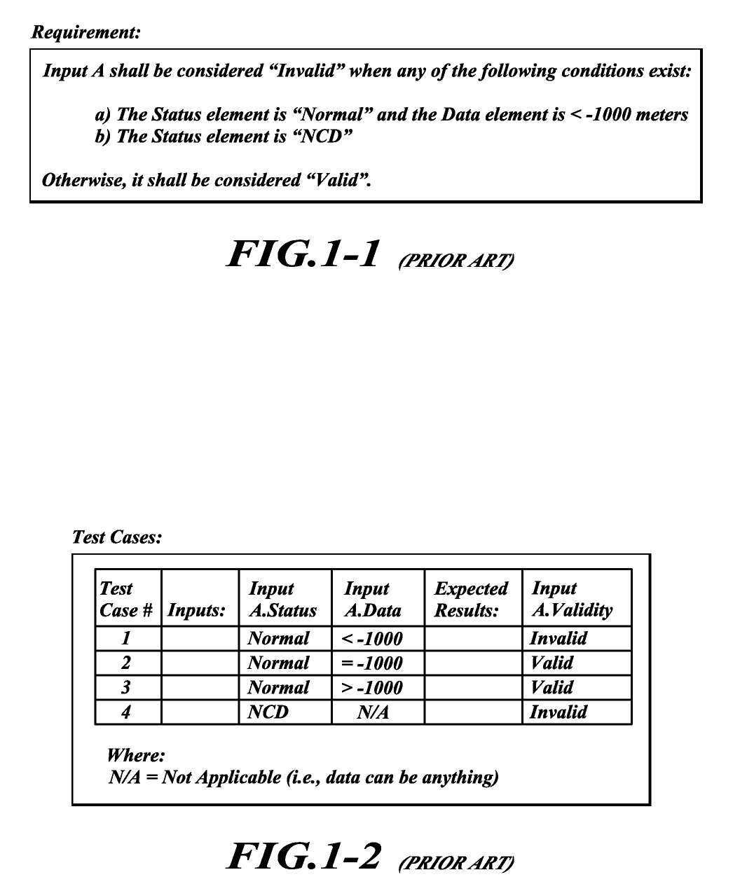

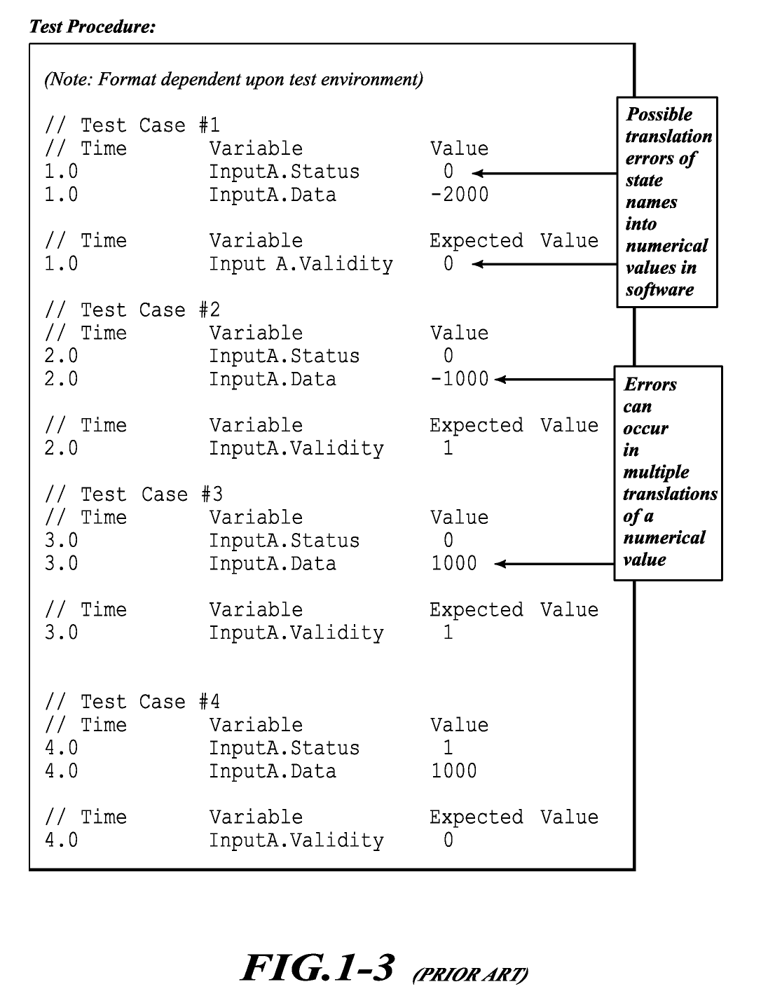

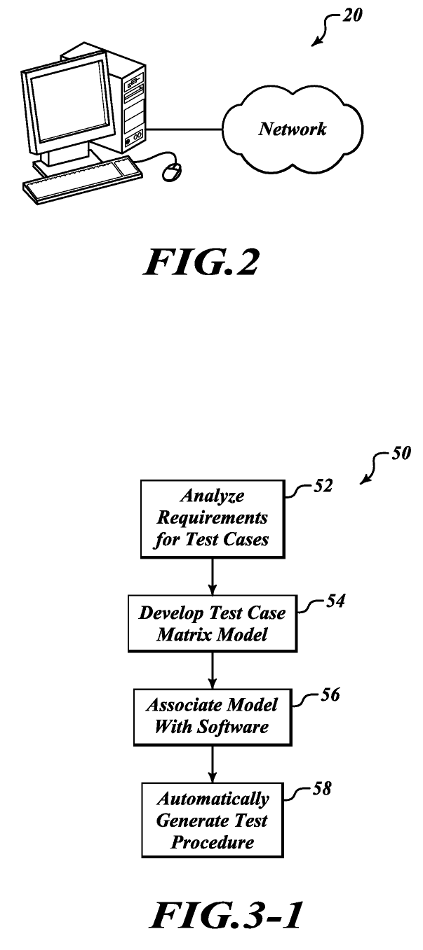

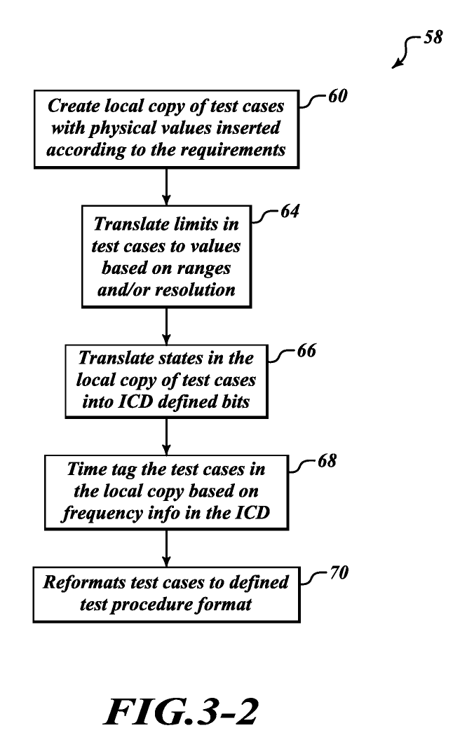

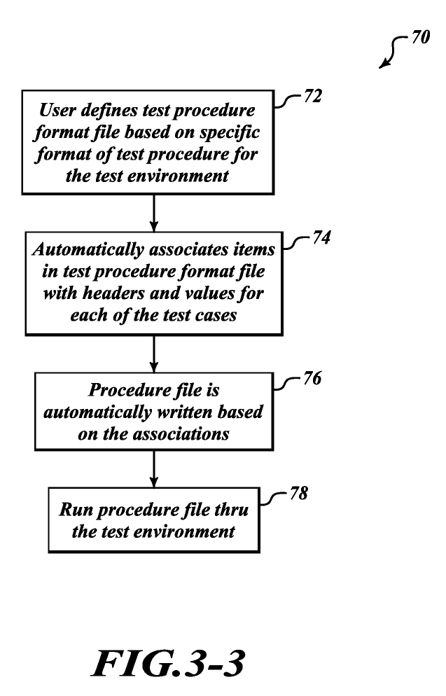

FIG. 3-1 illustrates an example process 50 as performed at least partially by the software embedded on the computer system 20 shown in FIG. 2. First, at a block 52, an operator analyzes previously defined requirements for test cases. Next, at a block 54, the operator develops a test-case matrix model based on the analyzed requirements. Then, at a block 56, the operator generates an association between portions of the test-cases and values in the predefined requirements. Next, at a block 58, a processor of the system 20 automatically generates test procedures based on the created associations.

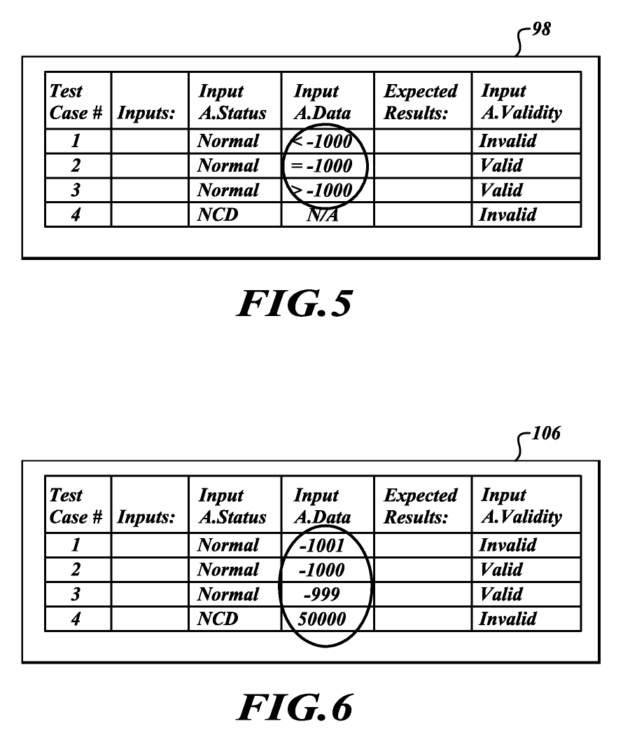

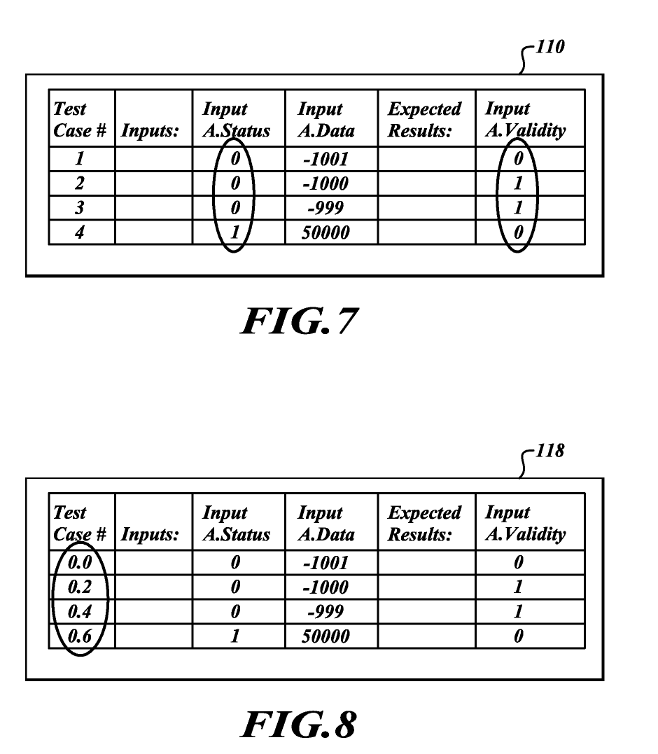

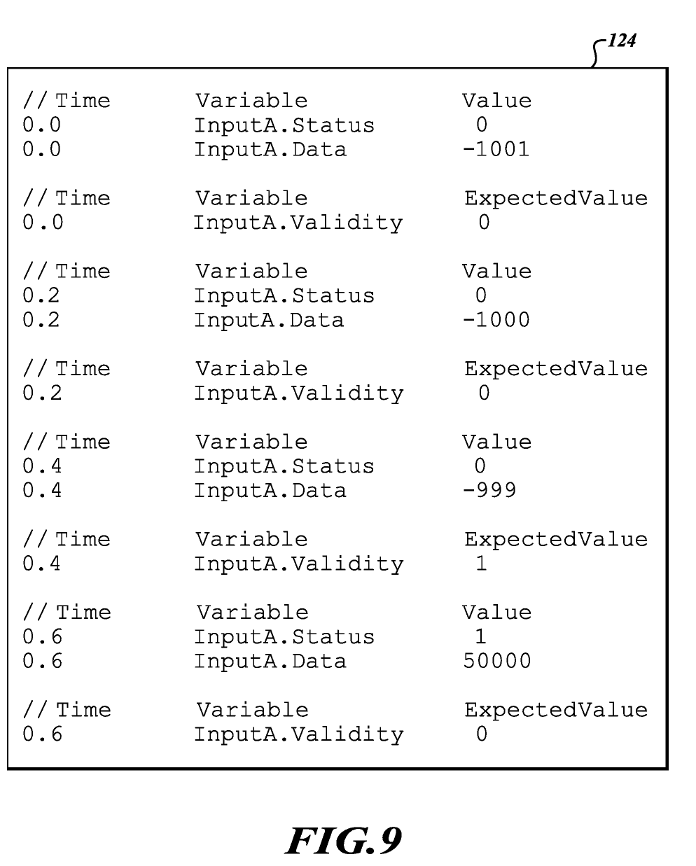

FIG. 3-2 illustrates details regarding the step performed at block 58 of FIG. 3-1. First, at a block 60, a local copy of predefined test case(s) are created. The local copy includes physical values inserted in the test cases based on the requirements. This step is described in more detail below with regard to the example of FIG. 5. At a block 64, limits in the test cases (local copy) are translated into values based on resolution and/or range values included in the ICD according to the matching. This step is described in more detail below with regard to the example of FIG. 6.

At block 66, states in the test cases (local copy) are translated into associated bits defined in the ICD. This step is described in more detail below with regard to the example of FIG. 7. At a block 68, time tags are applied to the test cases (local copy) based on frequency information included in the ICD. This step is described in more detail below with regard to the example of FIG. 8. At a block 70, the test cases (local copy) are reformatted based on previously defined test procedure format file. The test procedure format file is defined according to the test harness/environment.

FIG. 3-3 illustrate details of the process performed at the block 70. First at a block 72, the user defines a test procedure format file based on specific format of test procedures for the test environment (e.g. Matlab). At a block 74, items in the test procedure format file are associated with headers and values for each of the test cases. Then at a block 76, a procedure file is automatically written based on the associations. The steps at blocks 74 and 76 are looped in order for the associations to occur for all the test cases. At a block 78, the procedure file can be run through the test environment in a traditional manner.

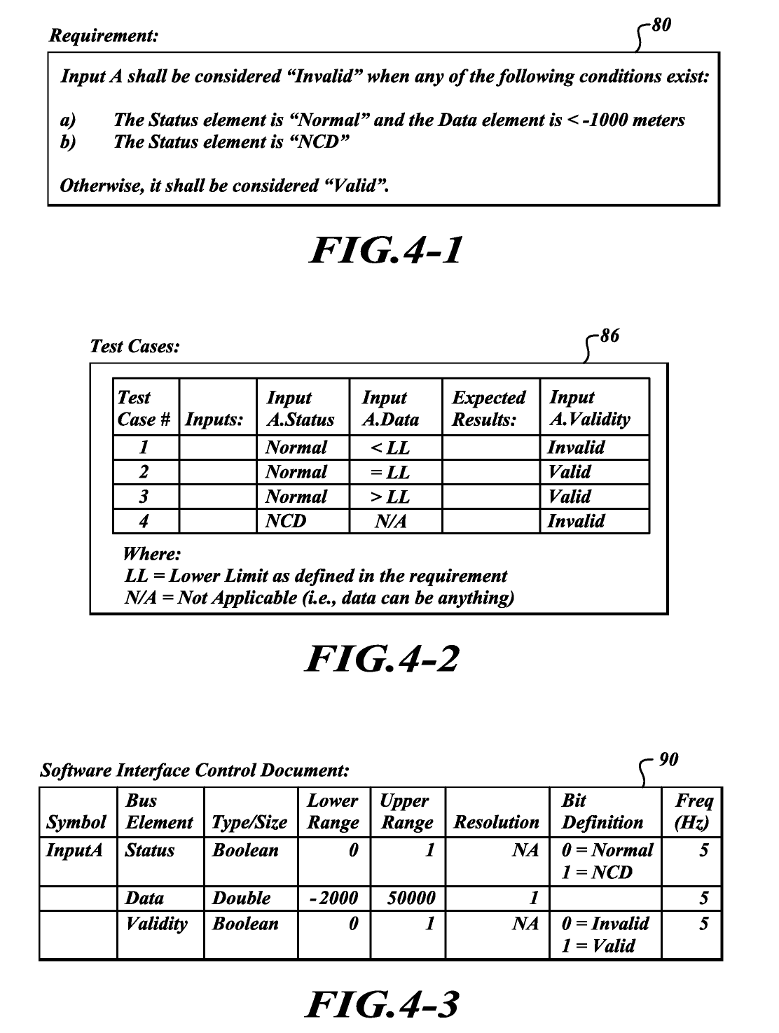

FIG. 4-1 illustrates example requirements 80 for an Input A for software under test. The requirements 80 identify when Input A is invalid or valid. FIG. 4-2 illustrates test cases 86 formed according to a testing engineer. In this example, if Input A status is “normal” then the data element (Input A) must be equal to or greater than a lower limit as defined in the requirements in order for the status of Input A to be considered valid, otherwise the status is considered invalid. If the Input A status is “NCD” (No Computed Data) then it doesn't matter what the Input A data element value is, the validity for Input A is considered invalid.

As shown in FIG. 4-3, a software interface control document (ICD) 90 is manually created by the operator/user. In this example, the ICD 90 is a table having the following columns: symbol; bus element; type/size; lower range; upper range; resolution; bit definition; and frequency (Hz). Then, the operator creates a link between the limit symbols (lower limit (LL)) in the test case 86 and the values in the requirements 80. The lower and upper range values are defined by a software developer as a part of the software development process. After the ICD 90 and the links between the test cases 86 and the requirements 80 have been completed, test procedure/test vectors are automatically generated as described below. Double in the Type/Size column means double-precision value.

As shown in FIG. 5 links to the requirements are translated into physical values and deposited into a local copy 98 of the test cases 86. In this example, because the lower limit is −1000, −1000 is inserted into the local copy 98 replacing LL with −1000. Next, the ICD 90 is automatically searched for matching symbols and the upper and lower ranges associated with the symbols are used to translate relational symbols (e.g., not equal, equal, less than, greater than) in the test cases 86 into values that fall within a range of the software and the test case limit, see FIG. 6. The resolution from the ICD 90 is used to adjust the greater than and less than values in the Input A.Data column. When a value is not explicitly defined (i.e., N/A), then either the upper or lower range values from the ICD 90 is randomly chosen.

Next, the ICD 90 is automatically searched for matching symbols. Also, states are translated into appropriate software bits as defined in the ICD 90. As shown in FIG. 7, the local copy 110 has been transformed to include zeros or ones respectively for Input A.Status and Input A.Validity based on the bit definitions included in the bit definition columns of the ICD 90. As shown in FIG. 8, the test cases in the local copy 98 are automatically translated into time tags based on the lowest frequency denoted in the frequency column of the ICD 90, thereby generating the test cases 118.

As shown in FIG. 9, test procedures 124 are automatically generated from the test cases 118 and a user defined test procedure (input file) format. The test procedures 124 is then applied to a test harness.

Below is an example of an input file format that the user defines (block 72) in order to generate the test procedures 124. For defining the input file format the user defines the comment tag, variable tagging. In this example, the comment tag has been defined to be //, and the variable tag has been defined to be <% variable_name>

| //Time | Variable | |
|---|---|---|
| | | Value |
| <%testcase> | <%input> | <%value> |
| | | Expected Value |
| <%testcase> | <%output> | <%expected_value> |

All comments lines in the test procedure format file are directly translated to the procedure file and all variable names are looped through as replacements as shown in this example. The process loops through the format file for each test case, where any lines that begin with // are directly translated to the test procedure. For each row in a test case matrix:
<% testcase> gets replaced with the number in the Test Case # column (FIG. 8) and becomes:

| //Time | Variable | Value |
|---|---|---|
| 0.0 | <%input> | <%value> |

The process loops through the columns between Inputs: & Expected Results and replace <% input> with the column name and place the value in that column in <% value>

### Example

| //Time | Variable | Value |
|---|---|---|
| 0.0 | InputA.Status | 0 |
| 0.0 | InputA.Data | −1001 |

1) The tool loops through the columns after the Expected Results and replace <% output> with the column name and place the expected value in that column in %<expected_value>

### Example

| //Time | Variable | |
|---|---|---|
| | | Value |
| 0.0 | InputA.Status | 0 |
| 0.0 | InputA.Data | −1001 |
| | | Expected Value |
| 0.0 | InputA.Validity | 0 |

2) The tool continues to loop through all the columns until the test case matrix has been completely converted into a test procedure.

Note that this tool has the capability of allowing all data in one test procedure, or splitting the data out into separate procedures. This is based purely on the function of how many formats are provided to the tool. The keywords the tool uses to generate the formats are <% testcase>, <% input>, <% value>, <% output>, <% expected value>

Since some test environments and test strategies have rules around formatting, timing between inputs, testing around limits, and comparing ranges around expected values, a test procedure generator can take in a settings file that defines this information for a set of test cases from which procedures can be generated.

With this setup, if any requirement limits are changed or ICD values are changed, the test procedure generator can automatically be re-run to generate new test procedures without a need to modify the test case. If the test procedures are automatically regenerated after each new software build, then these procedures will always be up-to-date with respect to the software and the requirements, eliminating the need to monitor and update the procedures with each change to requirements or software.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for automatically generating test procedures for a software test application, the method comprising:
receiving a test case model based on requirements associated with the software application under test;
receiving an interface control document, the interface control document provides associations of information between the requirements and the test case model; and
automatically generating test procedures for the software application under test based on the interface control document, the test case model, the requirements and a previously defined test procedure format file.

2. The method of claim 1, wherein automatically generating comprises automatically creating a local copy of the test case model based on the interface control document.

3. The method of claim 2, wherein the local copy comprises status values, data values and validity values as defined by the interface control document.

4. The method of claim 3, wherein the status values and the validity values are bit values as defined in the interface control document.

5. The method of claim 4, wherein the local copy comprises a test case number defined by frequency information included in the interface control document.

6. The method of claim 5, wherein automatically generating comprises automatically generating the test procedures based on the local copies of the test case model.

7. A system for automatically generating test procedures for a software application, the system comprising:
user interface means for creating a test case model based on requirements associated with the software application under test and for generating an interface control document, the interface control document provides associations of information between the requirements and the test case model; and
a means for automatically generating test procedures for the software application under test based on the interface control document, the test case model, the requirements and a previously defined test procedure format file.

8. The system of claim 7, wherein the means for automatically generating automatically creates one or more local copies of the test case model based on the interface control document.

9. The system of claim 8, wherein the one or more local copies each comprise status values, data values and validity values as defined by the interface control document.

10. The system of claim 9, wherein the status values and the validity values are bit values as defined in the interface control document.

11. The system of claim 10, wherein the one or more local copies each comprise a test case number defined by frequency information included in the interface control document.

12. The system of claim 11, wherein the means for automatically generating automatically generates the test procedures based on the one or more local copies of the test case model.

13. A system for automatically generating test procedures for a software application, the system comprising:
a user interface device; and
a processor in signal communication with the user interface device,
wherein a user operating the user interface device creates a test case model based on requirements associated with the software application under test and generates an interface control document, the interface control document includes associations of information between the requirements and the test case model,
wherein the processor is configured to automatically generates test procedures for the software application under test based on the interface control document, the requirements, the test case model and a previously defined test procedure format file.

14. The system of claim 13, wherein the processor automatically creates one or more local copies of the test case model based on the interface control document.

15. The system of claim 14, wherein the one or more local copies comprise status values, data values and validity values as defined by the interface control document.

16. The system of claim 15, wherein the status values and the validity values are bit values as defined in the interface control document.

17. The system of claim 16, wherein the one or more local copies comprise a test case number defined by frequency information included in the interface control document.

18. The system of claim 17, wherein the processor automatically generates the test procedures based on the one or more local copies of the test case model.
